(19) United States
(12) Patent Application Publication
(10) Pub. No.: US 2012/0163349 A1
(43) Pub. Date: Jun. 28, 2012

(54) TRANSMISSION METHOD IMPLEMENTED BY A NODE AND CORRESPONDING RECEPTION METHOD

(76) Inventors: Patrick Fontaine, Cesson Sevigne Cedex (FR); Charline Guguen, Cesson Sevigne Cedex (FR); Renaud Dore, Cesson Sevigne Cedex (FR)

(21) Appl. No.: 13/392,323

(22) PCT Filed: Sep. 7, 2010
(86) PCT No.: PCT/EP2010/063116

§ 371 Date: Feb. 24, 2012

(30) Foreign Application Priority Data
Sep. 8, 2009 (FR) 0956103

(51) Int. Cl. H04W 72/04

(52) U.S. Cl. 370/336

(57) ABSTRACT

The invention relates to a transmission method implemented by a first node of a first set of nodes comprising at least two nodes, characterized in that the method comprises a transmission step, intended for at least one second node of the first set, of at least one item of quiet information representative of a prohibition to send during at least one allocated time slot to at least one second set of nodes. The invention also relates to the corresponding reception method.

### FIELD OF THE INVENTION

The invention relates to the domain of telecommunications and more specifically to the management of a wired or wireless local network.

### PRIOR ART

According to the prior art, several WLAN (Wireless Local Area Network) or wired LAN (Local Area Network) architectures are known. Some of them use a single access point to cover a space such as a house or the landing of a building by the use, for example, of a high transmission power combined with different sophisticated technologies such as MIMO (Multiple Input Multiple Output) or OFDM (Orthogonal Frequency Division Multiplexing). Hence, an access point of a Wi-Fi® network (based on the 802.11n standard) reaches a real bitrate of 100 Mbit/s within a radius of 90 metres by means of MIMO and OFDM technologies and an access point of a HiperLAN2 network reaches a bitrate of 50 Mbit/s within a radius of 45 metres. Such architectures based on a single access point have the disadvantage of producing a high level of interference with respect to the surroundings and the risk of not covering all the space to cover, particularly in certain zones separated from the access point by physical obstacles, such as walls or partitions leading to strong attenuation in the transmitted signal. Moreover, the use of a high transmission power raises public health issues concerning the risks relating to a prolonged exposure to such electromagnetic radiation.

To overcome the aforementioned problems, it is known that a local network is implemented with a transmission power weaker than in single access point architectures, distributed over the space to cover and connected to each other by a wired backbone or wireless backbone. To be able to communicate with the network or between each other, the stations of a local network are each associated with a given access point. According to its position in the network, a given station associated with a given access point can also receive data packets sent by another access point, leading to risks of data packet collision at the level of the relevant station. With the increase in the number of stations present in a network, the risk of packet collision and therefore of data packet loss increases. Moreover, the channel access method used by certain protocols implemented in certain locations being of the random access type, for example of the ALOHA, CSMA (Carrier Sense Multiple Access) or CSMA/CA (Carrier Sense Multiple Access with Collision Avoidance) type, the risk of packet collisions is high, despite certain reservation mechanisms of the channel through the exchange of RTS/CTS (Request to Send/Clear to Send) frames implemented in the contention access mode for example (for example of the DCF (Distributed Coordination Function) type) of CSMA/CA type, that prove to be insufficient, particularly when the number of access points and stations present on the network is high.

Among the networks implementing an access method to the channel of the random type, it is possible to cite, for wired networks: GNeT using CSMA/CA, Apple's LocalTalk using CSMA/CA, Ethernet (based on the IEEE 802.3 standard) using CSMA/CD (Carrier Sense Multiple Access with Collision Detection) or ITU-T G.hn using CSMA/CA; and for the wireless networks: Wi-Fi® network (based on the IEEE 802.11-2007 standard) using CSMA/CA, WPAN (Wireless Personal Area Network, based on the IEEE 802.15 standard) using CSMA/CA or even WaveLAN using CSMA/CA.

### SUMMARY OF THE INVENTION

The purpose of the invention is to overcome these disadvantages of the prior art.

More particularly, a particular purpose of the invention is to optimise access to the channel.

The invention relates to a transmission method implemented by a first node of a first set of nodes comprising at least two nodes. The method comprises a transmission step, intended for at least one second node of the first set, of at least one item of quiet information representative of a prohibition to send during at least one allocated time slot to at least one second set of nodes, the at least one item of quiet information being comprised in at least one quiet element of a beacon frame.

Advantageously, the first set and the at least one second set use a same channel access method.

According to a particular characteristic, the channel access method is a channel access method by carrier detection.

In an advantageous manner, the method comprises a reception step of an item of information representative of allocation of the at least one time slot.

According to another characteristic, the method comprises a reception step of an item of information representative of a temporal synchronization.

In an advantageous manner, the first node is an access point, the at least one second node being associated with the said access point, and the at least one second set comprises an access point.

Advantageously, the first and second sets belong to a same network of the wireless local network type.

According to another characteristic, the first and second sets belong to a same network of the powerline type.

The invention also relates to a reception method implemented by at least one second node of a first set of nodes comprising at least two nodes, the method comprising a reception step of at least one item of quiet information representative of a prohibition to send during at least one time slot allocated to at least one second set of nodes, the quiet information being received from a first node of the first set, the at least one item of quiet information being comprised in at least one quiet element of a beacon frame.

Advantageously, the method comprises a positioning step of a network allocation vector according to the at least one item of quiet information.

### LIST OF FIGURES

The invention will be better understood, and other specific features and advantages will emerge upon reading the following description, the description making reference to the annexed drawings wherein:

FIG. 1 illustrates a wireless system implementing several subsets of nodes, according to a particular embodiment of the invention,

FIGS. 2 and 3 diagrammatically illustrate respectively an access point and a station of the system of FIG. 1, according to a particular embodiment of the invention,

FIG. 4 diagrammatically illustrates the structure of a communication frame of the system of FIG. 1, according to a particular embodiment of the invention,

FIG. 5 diagrammatically illustrates the content of a beacon frame transmitted by at least one node of the system of FIG. 1, according to a particular embodiment of the invention,

FIG. 6 diagrammatically illustrates the distribution of the fields of a quiet element in a communication frame according to the content of a beacon frame of FIG. 5, according to a particular embodiment of the invention,

FIG. 7 diagrammatically illustrates the structure of a communication frame of the system of FIG. 1, according to a particular embodiment of the invention,

FIGS. 8 and 9 illustrate a transmission method implemented by at least one node of the system of FIG. 1, according to particular embodiments of the invention, and

FIGS. 10 and 11 illustrate a transmission method implemented by at least one node of the system of FIG. 1, according to particular embodiments of the invention.

### DETAILED DESCRIPTION OF EMBODIMENTS OF THE INVENTION

The invention will now be described in a non-restrictive manner according to a particular embodiment implementing a Wi-Fi® type wireless local network (referring to the standards IEEE 802.11a, IEEE 802.11b, IEEE 802.11d, IEEE 802.11e, IEEE 802.11g, IEEE 802.11h, IEEE 802.11i, IEEE 802.11j (published by the IEEE under the reference IEEE 802.11™-2007 with, as title “IEEE Standard for Information technology—telecommunications and information exchange between systems—Local and metropolitan area networks—Specific requirements/Part 11: Wireless LAN Medium Access Control (MAC) and Physical Layer (PHY) Specifications”) or IEEE 802.11n). The invention is naturally not restricted to an implementation in a Wi-Fi® type network, the principles of the invention being applicable by those skilled in the art to any type of wired or wireless local network using a channel access method of the partially random type, for example of the ALOHA, CSMA, CSMA/CA or CSMA/CD type, for example to a wired local network of the GNeT type, Apple's LocalTalk, Ethernet (based on the IEEE 802.3 standard), ITU-T G.hn or to a WPAN type wireless local network (based on the IEEE 802.15 standard), WaveLAN or ALOHAnet.

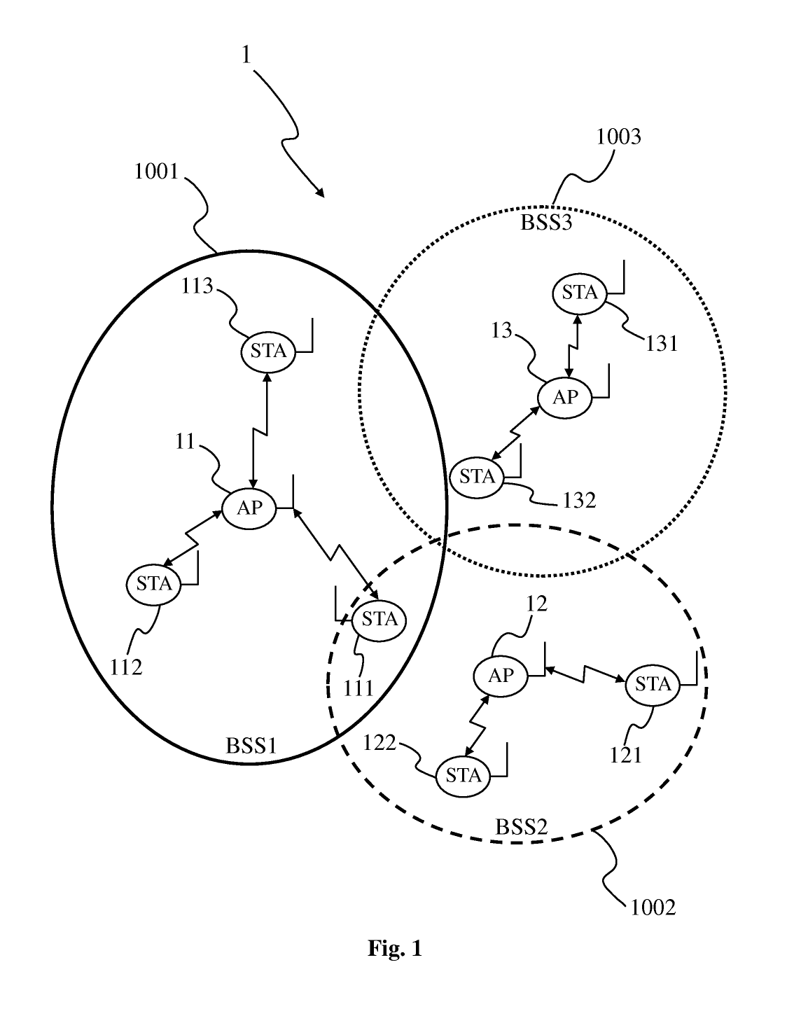

FIG. 1 illustrates a wireless communication system 1 of the wireless local network type according to a particular embodiment of the invention, implementing several nodes. In “ad hoc” mode, the nodes of the system 1 are connected directly between each other without using a third type of equipment such as an access point for example. In infrastructure mode of the network, one part of the nodes 11, 12 and 13 serve as mobile or fixed access points and the other part of the nodes 111, 112, 113, 121, 122, 131 and 132 serve as mobile or fixed stations. Stations 111, 112 and 113 are associated with the access point 11 for the communication (that is the transmission and/or reception) of data and form, with the access point 11, a first set BSS 1 (Basic Service Set); stations 121 and 122 are associated with the access point 12 for the communication of data and form, with the access point 12, a second set BSS 2; stations 131 and 132 are associated with the access point 13 for the communication of data and form, with the access point 13, a third set BSS 3. The three sets BSS1, BSS2 and BSS3 are advantageously connected to a distribution system DS to form an extended service set ESS. The transmission area covered by the access point 11 is shown by an oval with a solid line 1001, the transmission area covered by the access point 12 is shown by an oval with a dotted line 1002 and the transmission area covered by the access point 13 shown by a circle 1003 formed by dots. In other words, the areas 1001, 1002 and 1003 show the interference areas of respectively each of the access points 11 to 13. Within each of these areas 1001 to 1003, the interferences are greater than a given threshold value and the interferences are less than a given threshold value outside of these areas 1001 to 1003. Station 111, associated with the access point 11 of the BSS1, is in the coverage area of the access point 11 and in the one of the access point 12. Station 111 is able to exchange data (or data packets) with the access point 11 with which it forms the BSS1 and is able to receive data sent by the access point 12. Such an example is called OBSS (Overlapping Basic Service Sets), the interference area being larger than the coverage area. In advantageous manner, each BSS uses a different physical channel from the one used by the other BSSs, a physical channel being characterized by a group of parameters comprising a list of sub-carriers, a time slot, a level of interference and in the case of a CDMA access (Code Division Multiple Access) of a same spreading code. According to a variant, two BSSs, for example, the BSS1 and BSS2, use the same frequency band, for example license-free frequency bands, for example the 2.4 GHz or 5 GHz bands. The 5 GHz band corresponds for example to the frequency bands of which all the frequencies are between 5.15 GHz and 5.35 GHz or between 5.47 GHz and 5.875 GHz. A 5 GHz physical channel corresponds to a channel of width 10, 20 or 40 MHz, for example, all the frequencies of which are in one of the frequency intervals mentioned above. The 2.4 GHz band corresponds for example to the frequency bands of which all the frequencies are between 2.4 GHz and 2.5 GHz. A 2.4 GHz physical channel corresponds to a channel of width 22 MHz, for example, all the frequencies of which are in the frequency interval (2.4-2.5 GHz) mentioned above.

Advantageously, the access points 11, 12 and 13 are linked to each other and connected to the distribution system DS by a wired link, for example of the type MoCA (Multimedia over Coax Alliance), Ethernet, PLC (Powerline Communication), POF (Plastic Optical Fiber) or even ITU G.hn (corresponding to the standard for the next generation domestic network technologies of ITU, International Telecommunication Union). According to a variant, the access points 11, 12 and 13 are linked to each other by a wireless link, for example of the type Wi-Fi, Bluetooth (based on the IEEE 802.15.1 standard), WiMAX (based on the IEEE 802.16d or IEEE 802.16e standard) or event 3G (based on the IMT-2000 standard, International Mobile Telecommunications-2000).

In an advantageous manner, the access points 11, 12 and 13 of the system 1 are fixed devices. At least one of the access points 11, 12 and 13 forms a system covering a picocell, that is a small area, such as the inside of a building or supermarket, that is having a range of several tens of metres (for example less than 50 m). According to another variant, at least one of the access points 11, 12, 13 forms a system designed to cover a femtocell, i.e. a restricted area smaller than a picocell, like some rooms of a house or of a building, a floor of a building, an aircraft, i.e. having a range of a few metres (for example, less than 10 m). According to another variant, the access points 11, 12, 13 are mobile devices.

Stations 111 to 113, 121, 122, 131 and 132 are either mobile or fixed devices, for example a mobile phone, a laptop, a personal computer, personal digital assistant.

According to a variant, all the stations 111 to 113, 121, 122, 131 and 132 are of the SISO (‘Single Input Single Output’) type and only have one single antenna. In the same way, all the access points 11 to 13 are of the SISO type.

According to another variant, all the stations 111 to 113, 121, 122, 131 and 132 are of the MIMO type and have several antennas transmitting a MIMO signal. In the same way, all the access points 11 to 13 are of the MIMO type.

According to another variant, some stations 111 to 113, 121, 122, 131 and 132 (respectively some access points 11 to 13) of the system 1 are of the MIMO type and the others are of the SISO type.

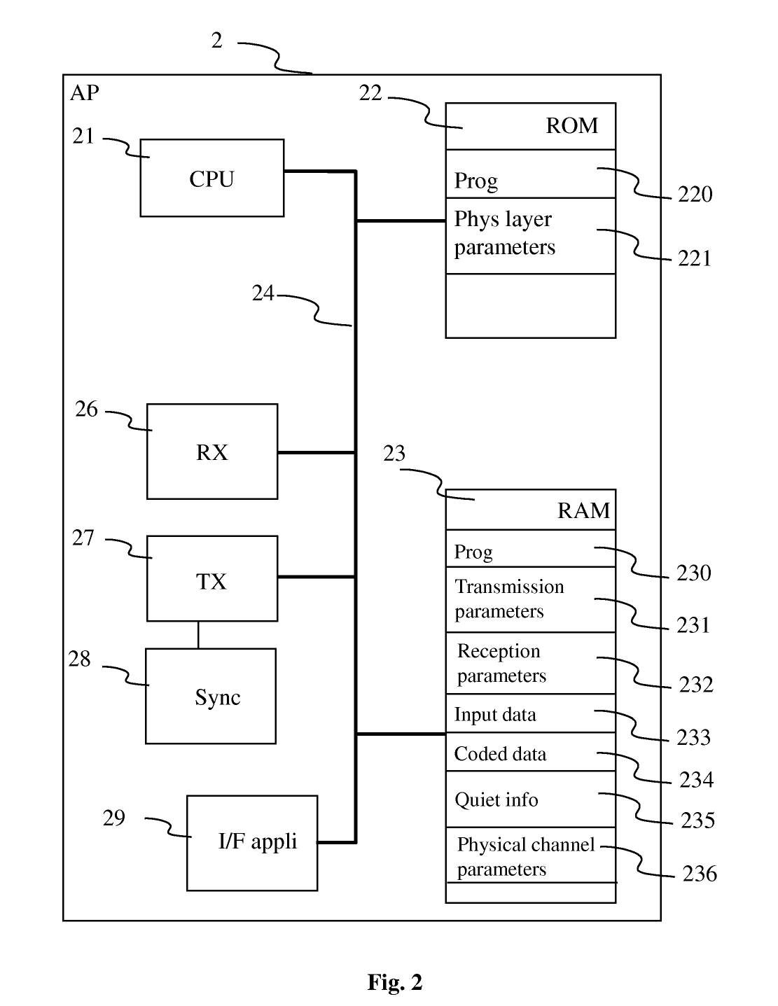

FIG. 2 diagrammatically illustrates a hardware embodiment of an access point 2 corresponding for example to the nodes 11, 12, 13 of FIG. 1.

The base station 2 comprises the following elements, connected to each other by an address and data bus 24, which also transports a clock signal:
a microprocessor 21 (or CPU),
a non-volatile memory of the ROM (Read Only Memory) type 22,
a Random Access Memory (RAM) 23,
a radio interface 26,
an interface 27 suitable for the transmission of data (for example broadcasting of services or multipoint to point or point to point transmission) and notably performing the functions of a coder and/or OFDM modulators,
an interface 28 suitable for receiving a synchronisation signal and for synchronising the interface 27, and/or
an MMI (Man Machine Interface) interface 29 or a specific application adapted for the display of information for a user and/or the input of data or parameters (for example, the parameterization of sub-carriers and data to be transmitted).

It is noted that the word “register” used in the description of the memories 22 and 23 designates, in each of the memories mentioned, a memory zone of low capacity (some binary data) as well as a memory zone of large capacity (enabling a whole programme to be stored or all or part of the data representative of data received or to be broadcast).

The memory ROM 22 comprises in particular:
a “prog” 220 program, and
parameters 221 of physical layers.

The algorithms implementing the steps of the method specific to the invention and described below are stored in the ROM 22 memory associated with the access point 2 implementing these steps. When powered up, the microprocessor 21 loads and runs the instructions of these algorithms.

The random access memory 23 notably comprises:
in a register 230, the operating program of the microprocessor 21 responsible for switching on the base station 2,
the transmission parameters 231 (for example, modulation, coding, MIMO, frame recurrence parameters),
the reception parameters 232 (for example, modulation, coding, MIMO, frame recurrence parameters), the incoming data 233,
the coded data 234 for the transmission of the data,
an item of quiet information 235, and
the physical channel parameters 236 (for example, allocation of a determined time slots, of a determined code and/or determined subcarrier intervals upon sending data by the access point 2).

The radio interface 26 is suitable to the reception of signals sent, if required, by the nodes 111 to 113, 121, 122 and 131, 132 of the system 1.

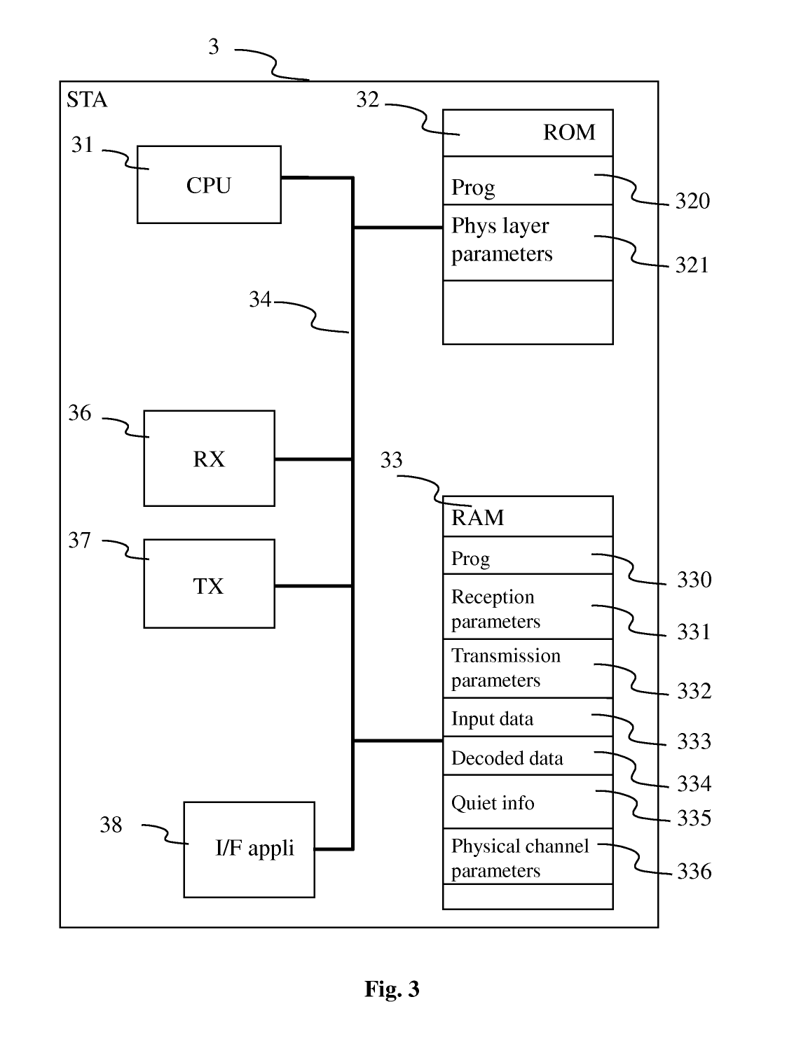

FIG. 3 diagrammatically illustrates a hardware embodiment of a station 3 belonging to the system 1, corresponding for example to the nodes 111 to 113, 121, 122 and 131, 132 and suitable for the reception and decoding of the signals sent by the access point 2.

The station 3 comprises the following elements, connected to each other by an address and data bus 34, which also transports a clock signal:
a microprocessor 31 (or CPU),
a non-volatile memory of the ROM (Read Only Memory) type 32,
a Random Access Memory (RAM) 33,
a radio interface 36, and
an interface 37 suitable for the transmission of data, and
an MMI interface 38 adapted for the display of information for a user and/or the input of data or parameters (for example, parameterization of sub-carriers and transmitted data).

It is noted that the word “register” used in the description of the memories 32 and 33 designates, in each of the memories mentioned, a memory zone of low capacity as well as a memory zone of large capacity (enabling a whole programme to be stored or all or part of the data representative of sets of data received or decoded).

The memory ROM 32 comprises in particular:
a “prog” 320 program, and
parameters 321 of physical layers.

The algorithms implementing the steps of the method specific to the invention and described below are stored in the ROM memory 32 associated with the station 3 implementing these steps. When powered up, the microprocessor 31 loads and runs the instructions of these algorithms.

The random access memory 33 notably comprises:
in a register 330, the operating programme of the microprocessor 31 responsible for switching on the terminal 3,
the reception parameters 331 (for example, modulation, coding, MIMO, frame recurrence parameters),
the transmission parameters 332 (for example, modulation, coding, MIMO, frame recurrence parameters),
incoming data 333 corresponding to the data received and decoded by the receiver 36,
decoded data 334 formatted to be sent to the interface to the application 39,
an item of quiet information 235, and
physical channel parameters 236 (for example, allocation of a determined frequency band, of a determined code upon the emission of data).

Other structures of the access point 2 and/or of the station 3 than those described with regard to FIGS. 2 and 3 are compatible with the invention. In particular, according to variants, base stations and/or mobile terminals compatible with the invention are implemented according to a purely hardware embodiment, for example in the form of a dedicated component (for example, in an ASIC or FPGA or VLSI) (respectively, ‘Application Specific Integrated Circuit’, ‘Field Programmable Gate Array’, ‘Very Large Scale Integration’) or of several electronic components integrated into a device or in the form of a mixture of hardware elements and software elements.

The radio interface 36 is adapted for the reception of signals sent by the nodes 11, 12 and 13 of the system 1.

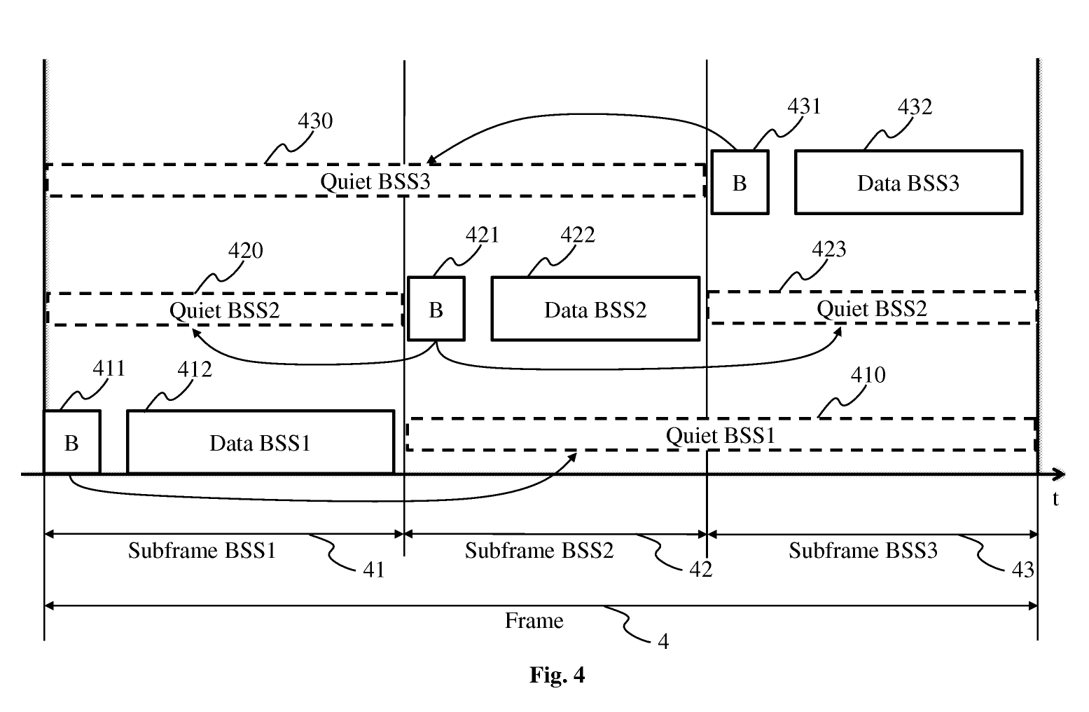

FIG. 4 diagrammatically illustrates the structure of a communication frame of the system 1, according to a particularly advantageous non-restrictive implementation embodiment of the invention.

The communication frame 4 is temporally divided into three subframes 41, 42, 43, each subframe being allocated to communications being set up between the nodes of a given BSS. In the case of an “ad-hoc” mode network, the subframe 41 is allocated to BSS1, the subframe 42 is allocated to BSS2 and subframe 43 is allocated to BSS3. In the case of an infrastructure mode network, each subframe is allocated to the access point of each BSS. In the system 1, the subframe 41 is allocated to the access point 11 of BSS1, the subframe 42 is allocated to the access point 12 of BSS2 and subframe 43 is allocated to the access point 13 of BSS3. In each subframe, the nodes of the associated BSS (or the access point and the stations that are associated with it in infrastructure mode) use the standard MAC mechanisms of the IEEE 802.11-2007 standard known by those skilled in the art: mechanisms of the CSMA/CA with for example the use of RTS/CTS frames to reserve the channel, the backoff, QoS EDCA quality of service, A-MPDU, ACK frame reception acknowledgement block, etc. or any other mechanism described in the IEEE 802.11-2007 standard. In an advantageous manner, the allocation of temporal subframes of the communication frame to the BSS is made by a controller. The controller is, for example, a device dedicated to the ESS network of the system 1 or belonging to the service distribution network not shown in FIG. 1. Each access point of the ESS network comprising the three BSSs receives, from the controller, an item of information representative of the allocation of the subframes. According to a variant, one of the access points of the ESS operates as a controller and sends the information representative of the allocation to the other access points. According to another variant, the allocation of the subframes is recorded in the memory of each access point of the BSS1, BSS2 and BSS3, for example by a controller user of the network.

During the first subframe 41, the access point 11 of BSS1 sends a beacon frame 411 to the stations 111, 112 and 113 that are associated with it. The beacon frame advantageously comprises an item of quiet information representative of the prohibition to send during the subframes 42 and 43 allocated respectively to BSS2 and BSS3. Upon receiving this prohibition to send during subframes 42 and 43, the stations 111, 112 and 113 each position their network allocation vector NAV (in accordance with the IEEE 802.11-2007 standard), thus preventing any transmission of data during the time slot or slots corresponding to the subframes 42 and 43. The access point 11 also positions its NAV during the same time slot or slots. The communication of data between the access point 11 on the one hand and the stations 111 to 113 on the other is carried out during the slot or slots 412 and a quiet 410 is imposed on the nodes of BSS1 during the time slot or slots allocated to the subframes 42 and 43.

During the second subframe 42, the access point 12 of BSS1 sends a beacon frame 421 to the stations 121 and 122 that are associated with it. The beacon frame 421 advantageously comprises an item of quiet information representative of the prohibition to send during the subframes 41 and 43 allocated respectively to BSS1 and BSS3. Upon reception of this prohibition to send during the subframes 41 and 43, the access point 12 and the stations 121 and 122 each position their network allocation vector NAV, thus preventing them from sending any data during the time slots corresponding to the subframes 41 and 43. The communication of data between the access point 12 on the one hand and the stations 121 and 122 on the other is carried out during the time slot or slots 422 and a quiet 420, 423 is imposed on the nodes of BSS2 during, respectively the time slot or slots of the subframes 41 and 43.

During the third subframe 43, the access point 13 of BSS3 sends a beacon frame 431 to the stations 131 and 132 that are associated with it. The beacon frame 431 advantageously comprises an item of quiet information representative of the prohibition to send during the subframes 41 and 42 allocated respectively to BSS1 and BSS2. Upon reception of this prohibition to send during the subframes 41 and 42, the access point 13 and the stations 131 and 132 each position their network allocation vector NAV, thus preventing them from sending any data during the time slots corresponding to the subframes 41 and 42. The communication of data between the access point 13 on the one hand and the stations 131 and 132 on the other is carried out during the time slot or slots 432 and a quiet 430 is imposed on the nodes of BSS3 during, respectively the time slot or slots of the subframes 41 and 42.

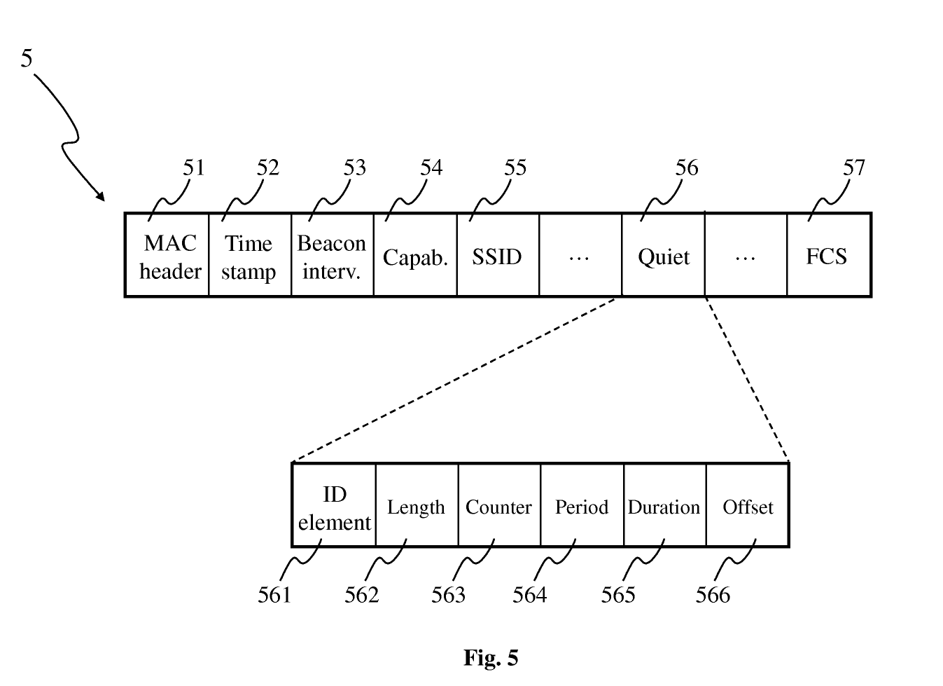

FIG. 5 diagrammatically illustrates the content of a beacon frame according to a particularly advantageous non-restrictive implementation embodiment of the invention.

The beacon frame 8 is advantageously compliant with the standard IEEE 802.11-2007. The MAC header (Medium Access Control Header) 51 contains information representative of the source and destination MAC addresses, the address destination being for example set to contain all the addresses of the stations (corresponding to a broadcast type address of the BSS considered to force all the stations of the BSS considered to receive and process each beacon frame. The MAC header field 51 also comprises, for example, the type and subtype of the frame (for example type=management frame, sub-type=beacon) or even the identifier of the BSS BSSID comprising the access point sending the beacon frame (corresponding for example to the source address, namely to the address of the access point sending the beacon frame).

The beacon frame body comprises all the fields placed between the MAC header and an FCS field (Frame Check Sequence). The timestamp field 52 contains information representative of a time used by a station to update its local clock. This information allows the stations associated with the access point sending the beacon frame to become synchronised.

The beacon interval field 53 comprises an item of information representative of the time between the sending of two beacon frames. This information notably enables stations wanting to set themselves to a standby status to know when they must set themselves to a listening status to receive the beacon frame. The beacon interval can for example be configured to 100 time units TU, namely 100*1024 μs=102.4 ms.

The capability information field 54 comprises representative information of the prerequisites necessary for a station to belong to the BSS comprising the access point having sent the beacon frame, such as, for example, the necessity of using a WEP key (Wired Equivalent Privacy) to participate in the network or even for example representative information of the Dynamic Frequency Selection support. To indicate the Dynamic Frequency Selection, the capability field 54 comprises spectrum management information resulting, for example, in a spectrum management bit set to 1. A station receiving this information must set dot11SpectrumManagementRequired to true before being associated with the access point having sent the beacon frame. If a station does not support spectrum management, the latter cannot be associated with the BSS considered.

The SSID field (Service Set Identifier) comprises representative information of the identification of the BSS comprising the transmitter access point of the beacon frame. Before being able to be associated with a particular BSS, a station must have the same SSID as the access point. The access point must include the SSID by default in the beacon frame that it sends. The quiet field 56 comprises representative information of a quiet element, that is information prohibiting the access point and the stations belonging to a same BSS to send data or data packets during one or more given time slots of one or more communication frames of a network. The quiet field comprises several fields, including:
an “ID element” field 561 comprising representative information of the identifier of the quiet element, a quiet element being identified by the ID 40 in the standard 802.11-2007,
a “Length” field 562 comprising representative information of the total length (in bytes) of the fields following the length field and specific to the quiet element, this length being 8 bytes according to the standard 802.11-2007; together with four fields specific to a quiet element:
a “counter” field 563 comprising representative information on the TBTT number up to the next beacon interval during which the quiet interval will start. A value of 1 for the “Counter” field means that the next quiet interval will start during the beacon interval following the next TBTT, that is following the first TBTT positioned after the beacon frame describing the quiet element considered is sent,
a “Period” field 564 comprising representative information on the number of beacon intervals that there are between quiet intervals corresponding to a quiet element of a same BSS,
a “Duration” field 565 comprising representative information of the duration of a quiet interval represented for example by a number of time units TUs, for example 44 TU, namely 44*1024 μs=45.056 ms, This duration corresponds to the duration for which the access point and the stations of a given BSS cannot send data, and
an “Offset” field 566 comprising representative information of the offset, expressed in time units TU, existing between the start of the quiet interval and the Target Beacon Transmission Time TBTT (for example 6 TUs), the relevant TBTT being specified in the “Counter” field 563.

In an advantageous manner, the beacon frame 5 describes several quiet elements (for example 2, 3, 5, 10 or 20), that is that the frame 5 comprises several quiet fields, each quiet field comprising a quiet element. Each quiet field only being associated with a single quiet element, the beacon frame 5 contains as many quiet fields as there are quiet elements described in the beacon frame. When a communication frame of a network comprising for example 2 BSSs is for example divided into 10 subframes, 5 subframes being allocated to each of the BSSs, the beacon frame sent by the first BSS comprises for example five quiet fields for the description of five quiet elements each corresponding to one of the five subframes allocated to the communication of the second BSS and the beacon frame sent by the second BSS comprises for example five quiet fields for the description of five quiet elements each corresponding to one of the five subframes allocated to the communication of the first BSS.

The beacon frame 5 also comprises an FCS field (Frame Check Sequence) or a CRC field (Cyclic Redundancy Checking) used to for correction and error detection.

For an “ad hoc” mode network, in which there is no access point in a BSS, one of the nodes performs the transmission of the beacon frame. Upon reception of the beacon frame, each node of the BSS waits for the end of the beacon interval (that is the next TBTT) and sends a beacon frame if no node has done so after the passage of a random time period. Such a process ensures that at least one node sends a beacon and the random time enables the node transmitting the beacon to vary over time.

In an advantageous manner, each beacon frame sent by a node or access point comprises the description of the quiet element or elements.

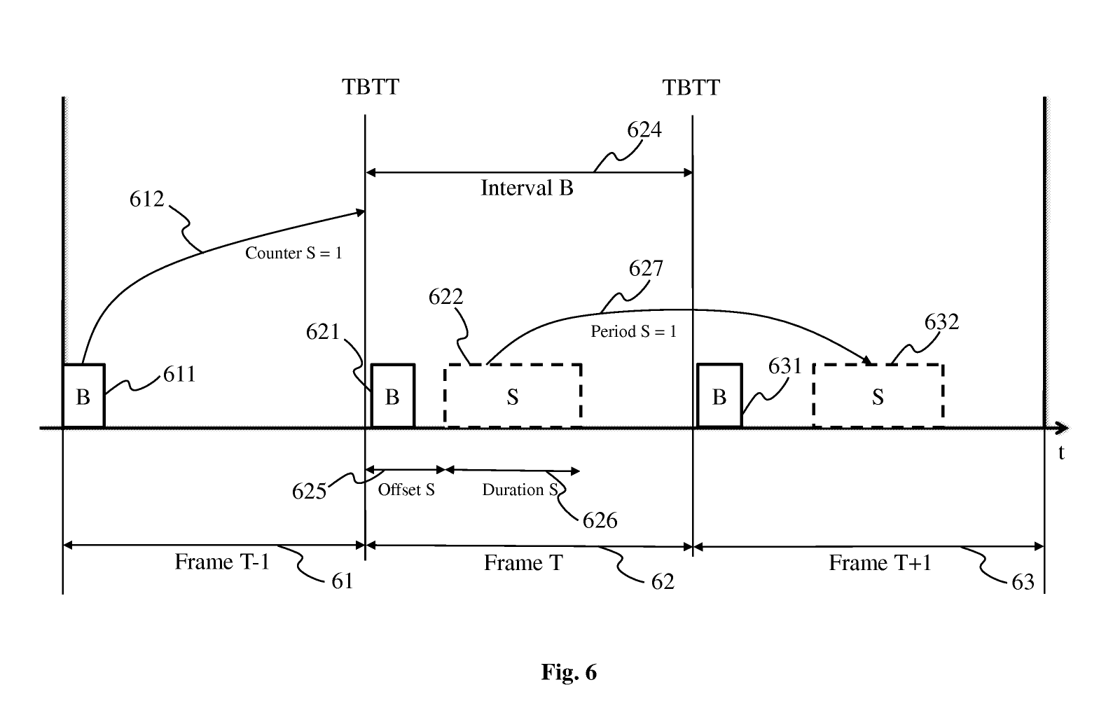

FIG. 6 diagrammatically illustrates the distribution of quiet elements in a communication frame according to information relative to the quiet elements contained in a beacon frame as described with respect to FIG. 5, according to a particular non-restrictive implementation mode of the invention.

Three successive communication frames T−1, T and T+1 referenced respectively 61, 62 and 63 are shown in FIG. 6. During the first frame T−1, a beacon frame (or beacon) 611 is sent by an access point of the BSS to the stations of the BSS associated with the access point of the BSS (or sent by a node of a BSS to other nodes of the BSS if the network comprising the BSS is in ad hoc mode). As this has been described with respect to FIG. 5, the beacon frame comprises a quiet field comprising representative information of a quiet element, the quiet field being divided into several fields each comprising representative information of parameters characterizing the quiet element. Among these parameters, the parameter corresponding to the quiet counter has the value 1, that is that the quiet interval starts at the TBTT (Target Beacon Transmission Time) following the beacon frame 611 comprising this information and that consequently the quiet interval 622 is positioned during the beacon interval 624 following the next TBTT, namely during the frame T 62. If this parameter has the value 2, the quiet interval would start during the beacon interval following the second TBTT following the transmission of the beacon frame 611, that is during the frame T+1 63, and so on. The quiet element of the beacon frame 611 also comprises representative information of the temporal offset 625 applied to the quiet interval 622, that is the offset between the start of the time slot 622 and the TBTT following the transmission of the beacon 611. the quiet element also comprises representative information of the duration of the quiet interval 622, expressed in time units TU, and represented by the duration S 626 in FIG. 6. Finally, the quiet element of the beacon frame 611 comprises representative information of the quiet period 627 taking the value 0, 1, 2, 3, 5 or 10 for example. This value corresponding to the number of beacon intervals existing between two quiet intervals. With a quiet period having 1 as value, the quiet interval 622 is repeated periodically once 632 at each beacon interval. If the value of the period parameter is equal to 2, the quiet interval is positioned every 2 beacon intervals, and so on. If the value of the period parameter is equal to 0, the quiet interval is positioned once. In an advantageous manner, the beacon frame 621 also comprises a quiet field comprising representative information of parameters of one or more quiet elements. The quiet element or elements described in the beacon frame 621 advantageously have as parameter values the same values as the quiet element or elements described in the beacon frame 611. According to a variant, the description of the quiet elements of the beacon frame 621 is different from the description of the quiet element or elements of the beacon frame 611. This variant has the advantage of changing the setting of the quiet interval or intervals described by one or more quiet elements of a beacon frame over time, for example according to changes in the network. The values given to the parameters describing the quiet intervals of FIG. 6 have been given as an example and these parameters can naturally take other values.

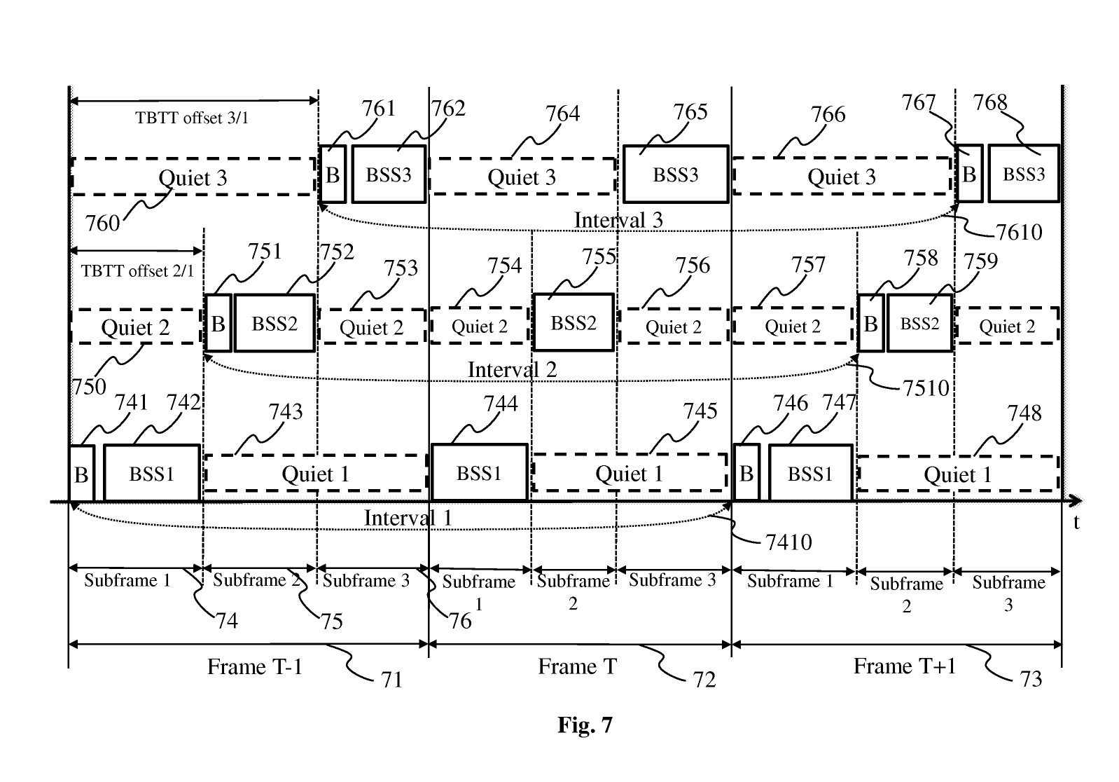

FIG. 7 diagrammatically illustrates the structure of a communication frame of the system 1, according to a particularly advantageous non-restrictive implementation embodiment of the invention.

Three successive communication frames T−1, T and T+1 referenced respectively 71, 72 and 73 are shown in FIG. 7. Each of these frames comprise three subframes (numbered 1, 2 and 3) 74, 75 and 76, each subframe being allocated to the communications being set up between the nodes of a given BSS. The first subframe 1 74 is allocated to the communications being set up between the nodes of BSS1, the second subframe 2 75 is allocated to the communications being set up between the nodes of BSS2 and the third subframe 3 76 is allocated to the communications being set up between the nodes of BSS3.

During the first subframe 1 of the frame T−1 allocated to BSS1, the access point 11 of BSS1 sends a beacon frame 741 to stations 111, 112 and 113 that are associated with it (or, in “ad hoc” mode, a node of BSS1 sends the beacon frame 741 to the other nodes of BSS1). The access point 11 sends a beacon every two frames, namely during the frame T−1 71 and during the frame T+1 73, no beacon being sent during the frame T. The beacon interval 1 7410 corresponding to the beacon sent by the access point 11 has a length equal to two communication frames. The communications between the access point and the stations of BSS1 are set up during the time slots 742, 744 and 747 of the subframes 1. The beacon interval 7410 having a length equal to 2 frames, the beacon 741 comprises the description of two quiet intervals 743 and 745, that is one for each communication frame. The quiet intervals prohibit any transmission to the nodes of BSS1 during the subframes 2 and 3, allocated respectively to BSS2 and BSS3, of respectively the frames T−1 71 and T 72. This results in the presence of two quiet elements (or “quiet” fields) in the beacon frame as described with respect to FIG. 5. According to a variant, the “quiet” fields describing the quiet intervals 743 and 745 are comprised in the beacon frame sent just before the beacon frame 741, that is during the communication frame T−3 not shown in FIG. 7, the “counter” parameter of these two quiet elements having the value 1, the next TBTT of the beacon frame sent during the start of the frame T−1, just before the transmission of the beacon 741. According to this variant, the parameters of the quiet interval 748 prohibiting any transmission to the nodes of BSS1 during the subframes (of the frame T+1) allocated to the BSS2 and BSS3 are described in the beacon frame 741.

During the second subframe 2 of the frame T−1 allocated to BSS2, the access point 12 of BSS2 sends a beacon frame 751 to the stations 121 and 122 that are associated with it. The access point 12 sends a beacon every two frames, namely during the frame T−1 71 and during the frame T+1 73, no beacon being sent during the frame T. The beacon interval 2 7510 corresponding to the beacon sent by the access point 12 has a length equal to two communication frames. The communications between the access point and the stations of BSS2 are set up during the time slots 752, 755 and 759 of the subframes 2 of the frames T−1, T and T+1. The beacon 751 comprises the description of four quiet intervals 753, 754, 756 and 757, that is one for each subframe existing between the transmission of two successive beacons 751 and 758. The quiet intervals prohibit any transmission to the nodes of BSS2 during the subframes 1 and 3, allocated respectively to BSS1 and BSS3. This results in the presence of four quiet elements (or four “quiet” fields) in the beacon frame as described with respect to FIG. 5. In an advantageous manner, the “quiet” fields describing the quiet intervals 753, 754, 756 and 757 are comprised in the beacon frame sent just before the beacon frame 751, that is during the communication frame T−3 not shown in FIG. 7, the “counter” parameter of these four quiet elements having the value 1, the next TBTT following the transmission of the beacon frame sent during the frame T−3 corresponding to the time following the end of the quiet interval 750 and preceding the beacon 751. In an advantageous manner, the temporal offset between the TBTT of BSS1 and the TBTT of BSS 2 (TBTT offset) is forced to a given value, for example by a network controller connecting the access points of the different BSSs. This value is chosen to reduce the risks of collision between a given packet sent by the access point of BSS1 and the beacon sent by the access point of BSS2, particularly on the start-up of the access point of BSS2.

During the third subframe 3 of the frame T−1 allocated to BSS3, the access point 13 of BSS3 sends a beacon frame 761 to the stations 131 and 132 that are associated with it. The access point 13 sends a beacon every two frames, namely during the frame T−1 71 and during the frame T+1 73, no beacon being sent during the frame T. The beacon interval 3 7610 corresponding to the beacon sent by the access point 12 has a length equal to two communication frames. The communications between the access point and the stations of BSS3 are set up during the time slots 762, 765 and 768 of the subframes 3 of the frames T−1, T and T+1. The beacon 761 comprises the description of two quiet intervals 764 and 766. The quiet intervals prohibit any transmission to the nodes of BSS3 during the subframes 1 and 2, allocated respectively to BSS1 and BSS2. This results in the presence of two quiet elements (or two “quiet” fields) in the beacon frame as described with respect to FIG. 5. In an advantageous manner, the “quiet” fields describing the quiet intervals 764 and 766 are comprised in the beacon frame sent just before the beacon frame 761, that is during the communication frame T−3 not shown in FIG. 7, the “counter” parameter of these two quiet elements having the value 1, the next TBTT following the transmission of the beacon frame sent during the frame T−3 corresponding to the time following the end of the quiet interval 760 and preceding the beacon 761. In an advantageous manner, the offset between the TBTT of BSS1 and the TBTT of BSS 3 is forced to a predetermined value to reduce the risks of collision between a given packet sent by the access point of BSS1 or by the access point of BSS2 and the beacon sent by the access point of BSS3, particularly on the start-up of the access point of BSS3.

In the case when the transmission of a beacon frame by one of the access points of BSS1, BSS2 and/or BSS3 is delayed in time, for example if the channel used for this transmission is busy with another node of the network formed by the BSSs or of another network, the quiet intervals of the different BSSs remain synchronised since these quiet intervals are relative to each TBTT of each BSS, the TBTT being expected and theoretical times, and not real times.

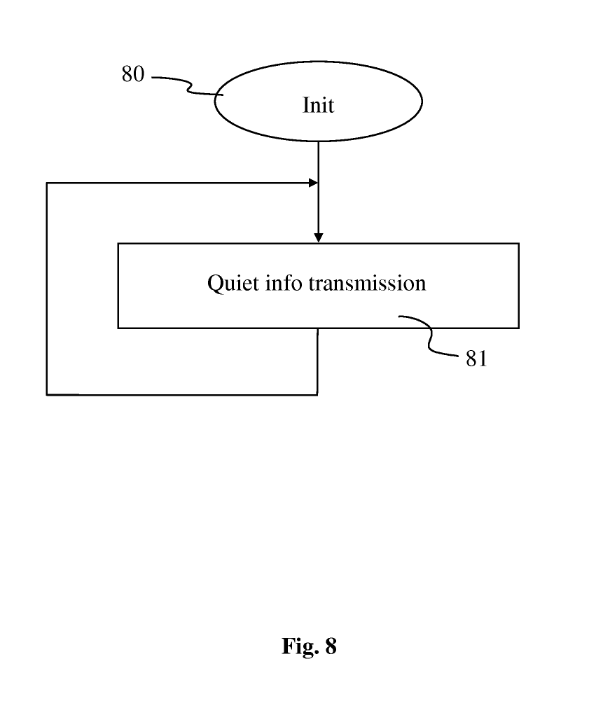

FIG. 8 illustrates a transmission method implemented by at least one node of the system 1, according to a particularly advantageous non-restrictive implementation embodiment of the invention.

During an initialization step 80, the various parameters of the at least one node are updated. In particular, the parameters corresponding to the signals to be sent and to the corresponding sub-carriers are initialized in any manner (for example, following the reception of initialization messages sent by a node of the network, called master node or by an access point of the network or by a controller or a server not represented of the system 1, or even by commands of an operator).

Next, during a step 81, a first node of a first set of nodes sends an item of quiet information to one or more nodes, called second node or nodes, of the first set of nodes. This item of quiet information comprises representative information of a prohibition to send data or data packets during one or more time slots allocated to one or more nodes of a second set of nodes. In an advantageous manner, the first and second sets of nodes form a network of the wireless local network type. The first and second sets of nodes correspond advantageously to a first and second basic service set, in accordance with the standard IEEE 802.11-2007, the BSS forming a network of the Extended Service Set ESS type. According to a variant, the first and second sets of nodes are formed in accordance with the standard IEEE 802.15 and together form a Wireless Personal Area Network (WPAN). According to another variant, the first and second sets of nodes form a network of the WaveLAN® type.

According to a variant, the first and second sets of nodes form a network of the wired local network type, for example of the ALOHAnet, GNeT, Apple's LocalTalk, Ethernet (based on the IEEE 802.3 standard) or ITU-T G.hn type.

In an advantageous manner, the nodes of the same set communicate with each other by using a channel access method by carrier detection, for example a method of the ALOHA, CSMA, CSMA/CA or CSMA/CD type. Each set of nodes advantageously uses the same channel access method, particularly by carrier detection.

According to a particularly advantageous implementation embodiment, the first and second sets of nodes form a Wi-Fi® network, in accordance with the IEEE 802.11-2007 standard, in infrastructure mode. The first node of the first set sending the quiet information is an access point, the second node or nodes of the first set receiving the quiet information being stations associated with the access point for setting up any communication with the network. The quiet information sent by the access point of the first set is received by the stations of the first set and comprises an item of information prohibiting the stations of the first set to send during one or more time slots allocated to the second set, and generally during one or more time slots allocated to other sets of nodes of the network different from the first set. The second set of nodes also comprises an access point, different from the access point of the first set, sending an item of quiet information for the station or stations of the second set, these stations being associated with the access point of the second set for setting up any communication with the network. The quiet information sent by the access point of the second set is received by the stations of the second set and comprises an item of information prohibiting the stations of the second set to send during one or more time slots allocated to the first set, and generally during one or more time slots allocated to other sets of nodes of the network different from the second set. According to a variant, the network comprises more than two sets of nodes, each set comprising an access point sending representative information of a prohibition to send during one or more time slots allocated to the other sets of the network, the information being sent by each access point to the stations that are associated with it. According to a variant, the sets of nodes forming the Wi-Fi® network operate in “ad hoc” mode in which the sets of nodes do not include any access point. One node of each set takes responsibility for sending the quiet information to the other nodes of the set, the node sending the quiet information changing advantageously over time according to the rules laid down by the “ad hoc” mode defined in the IEEE 802.11-2007 standard. According to another variant, the sets of nodes forming the Wi-Fi® network operate in mesh mode.

In an advantageous manner, the quiet information sent by a first node of the first set is comprised in a quiet element of a beacon frame, as defined in the IEEE 802.11-2007 standard. The quiet element advantageously comprises the description of a set of specific parameters enabling a quiet interval to be positioned by the nodes or stations of the first set receiving the quiet information. The set of parameters comprises the following parameters: quiet count, quiet period, quiet duration and quiet offset. According to a variant, the beacon frame comprises several quiet elements, each quiet element comprising the description of a set of specific parameters for a quiet interval. This variant can position several quiet intervals, particularly when a communication frame is divided into n subframes (n≧2) and when a quiet interval must be positioned per subframe by a given set of nodes.

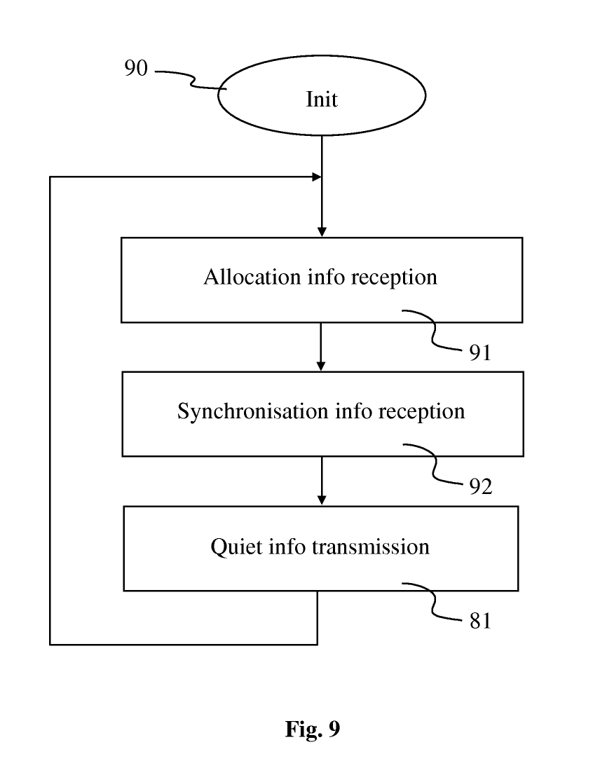

FIG. 9 illustrates a transmission method implemented by at least one node of the system 1, according to a particularly advantageous non-restrictive implementation embodiment of the invention.

During an initialization step 90, the various parameters of the at least one node are updated. In particular, the parameters corresponding to the signals to be sent and to the corresponding sub-carriers are initialized in any manner (for example, following the reception of initialization messages sent by a node of the network, called master node or by an access point of the network or by a controller or a server not represented of the system 1, or even by commands of an operator).

Next, during a step 91, a first node of a first set of nodes receives representative information of the allocation of one or more time slots to a second set of nodes. According to a variant, the first node receiving this information is the access point of the first set, the first set forming for example a first BSS according to the IEEE 802.11-2007 standard. This information is advantageously sent by a controller of the network formed by the sets of nodes. According to a variant, this information is sent by a controller belonging to a network, of the wired or wireless type, different from the one formed by the two sets of nodes and connecting for example each access point of each of the first and second sets to each other. A communication frame of the network formed by the first and second sets of nodes is advantageously divided temporally into as many subframes as there are sets of nodes, each temporal subframe being allocated to a different set of nodes for setting up communications within all the nodes concerned, communications within a set, and thus during a given temporal subframe, using a channel access method randomly or by carrier detection. According to a variant, a network communication frame is divided temporally into n subframes, n being less than the number of sets of nodes (or of BSSs) of the network. According to this variant, several subframes are allocated to a set of nodes or several distinct subframes are allocated to several sets of nodes for setting up communications in this set or these sets of nodes. In an advantageous manner, all the access points of each of the sets of nodes receive this representative information of the allocation of one or more time slots to each of the sets of nodes.

According to a variant, the step 91 is not implemented and the allocation information is not received by the first node (subsequently named access point) of the first set. According to this variant, the allocation of temporal subframes (or time slot or slots) is for example entered by a user or a controller of the network when the network is set up in a memory of each access point of each set of nodes. The implementation of the step for receiving the allocation information has the advantage of being able to vary the allocation of time slots (or temporal subframes) of a communication frame over time according to given parameters, such as for example:
the number of stations associated with an access point of a set, the duration of the subframe allocated being for example directly proportional to the number of stations of the corresponding set, or
the type of the data exchanged in a set (video, voice, etc.), the duration of the subframe allocated being greater for a set within which the nodes transmit or receive video data.

Then, during a step 92, the first node of the first set of nodes receives representative information of a temporal synchronisation. This information can synchronise the sets of nodes with each other (for example by synchronisation of a common clock to the access points of the different sets of nodes) and corresponds to a common time base. According to a variant, this information comprises information specifying the TBTT of each set of nodes. This information is advantageously received by the access point of each of the sets of nodes forming the network. This information enables the access points of each of the different sets of nodes to be perfectly synchronised with each other so that the transmissions of data by a given set of nodes correspond exactly to the quiet of the other sets of nodes, so as to prevent the collisions of data or data packets sent by nodes belonging to different sets of nodes. The signal containing the synchronisation information is advantageously sent by a controller of the network or by a controller of another network, wired or wireless, different from the network formed by the sets of nodes. According to a variant, this signal is sent by an access point of the network. This signal is advantageously sent periodically to ensure that the synchronisation between the access points of the network is the best possible. According to a variant, the signal comprising the synchronisation information is not sent periodically but at the request of an access point. In an advantageous manner, the signal comprising the synchronisation information and received by the access points also comprises the allocation information of time slots to the sets of nodes of the network. According to a variant, the signal comprising the synchronisation information is different from the signal comprising the allocation information and is for example sent with a different periodicity.

According to a variant, step 92 is not implemented and the synchronisation information is not received by the access point of the first set, or by the access point of the other sets of the network. According to this variant, the access points are synchronised with each other upon the set up of these access points by a controller of the network for example. The verification of the correct synchronisation of the access points with each other is advantageously performed regularly by a user via the management interface of the access point.

Finally, during a step 81 similar to the one described with regard to FIG. 8, the access point of the first set sends an item of quiet information to the station or stations of the first set that are assigned to it, prohibiting these stations from sending during the time slot or slots allocated to the other sets of nodes of the network. This step having already been described with regard to FIG. 8, it will not be described again here.

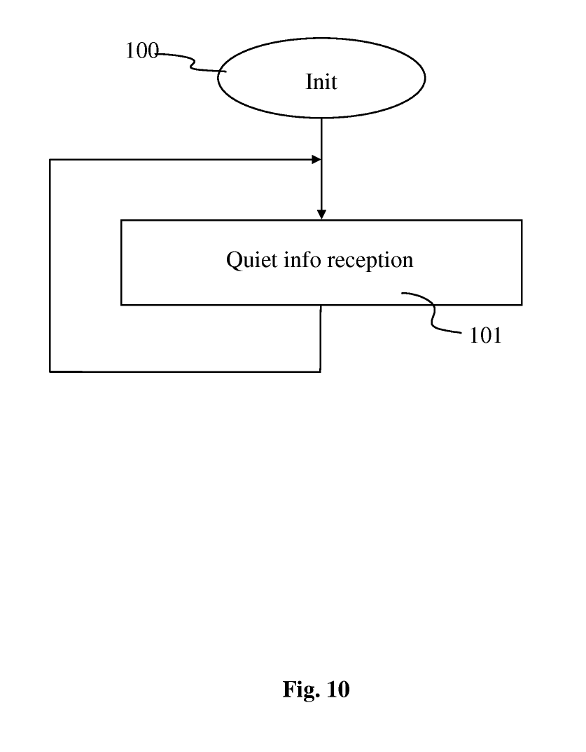

FIG. 10 illustrates a reception method implemented by at least one node of the system 1, according to a particularly advantageous non-restrictive implementation embodiment of the invention.

During an initialization step 100, the various parameters of the node are updated. In particular, the parameters corresponding to the signals to be sent or received and to the corresponding sub-carriers are initialized in any manner (for example, following the reception of initialization messages sent by another node or access point or by a server not represented of the system 1, or even by commands of an operator).

Then during a step 101, one or more second nodes (called station hereafter) of a first set of nodes receive an item of quiet information sent by a first node (called access point hereafter) of the first set of nodes. Once the information is received and decoded, the stations of the first set prohibit any transmission of data or data packets during one or more time slots allocated to one or more second sets of nodes. Such a prohibition to send data during time slots allocated to the communication of other sets of nodes can notably prevent the collision between data or data packets sent by two access points of two different sets for example and received by a station associated with one of the access points but in the area covered by the other access point. In a Wi-Fi type network formed by the different sets of nodes, such quiet information is advantageously comprised in one or more quiet elements of a beacon frame, in compliance with the IEEE 802.11-2007 standard. The stations compliant with the IEEE 802.11-2007 standard and supporting DFS spectrum management are able to decode such a quiet element and interpret the parameters contained in this quiet element so as not to send data during the time slot or slots allocated to the other sets of nodes. The stations not compliant with the 802.11-2007 standard or not supporting DFS, and more particularly not compliant with the IEEE 802.11h standard are not capable of decoding such a quiet element but can advantageously be associated with the access point sending the quiet information, particularly when the access point transmits in the 2.4 GHz frequency band. These non-compliant stations ignore the quiet information and can transmit during the time slots allocated to the communication of other sets of nodes, slightly increasing the risk of packet collision. In compliance with the IEEE 802.11-2007 standard, the nodes (station and access point) of a set sending and receiving data by using the 5.4 GHz frequency band support DFS (Dynamic Frequency Selection) procedures by default and are therefore able to decode a quiet element contained in a beacon frame.

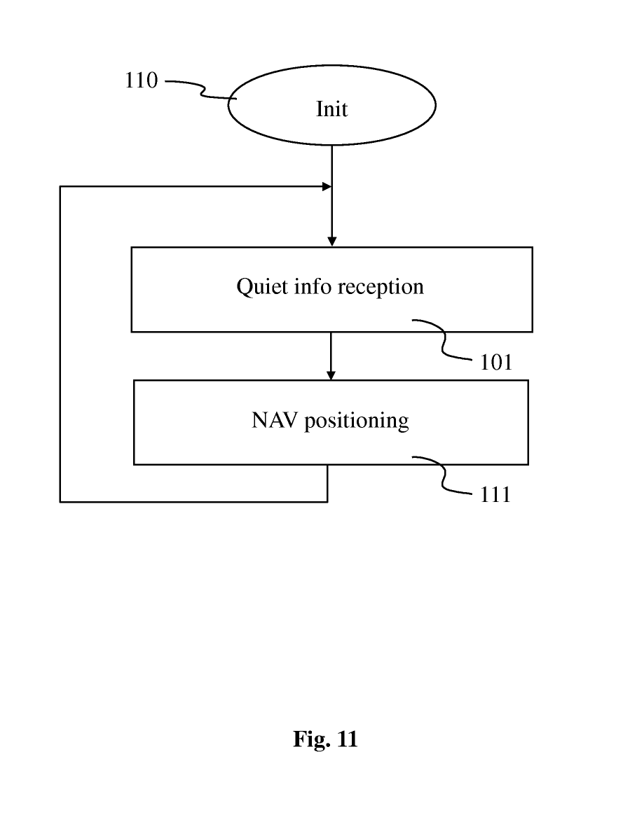

FIG. 11 illustrates a reception method implemented by at least one node of the system 1, according to a particularly advantageous non-restrictive implementation embodiment of the invention.

During an initialization step 110, the various parameters of the node are updated. In particular, the parameters corresponding to the signals to be sent or received and to the corresponding sub-carriers are initialized in any manner (for example, following the reception of initialization messages sent by another node or access point or by a server not represented of the system 1, or even by commands of an operator).

Then during a step 101, not described in detail, since identical to the step 101 described with regard to FIG. 10, one or more nodes of a first set of nodes receive, from a first node of the first set, representative quiet information of a prohibition to send during one or more time slots allocated to one or more second sets of nodes.

Finally, during a step 111, the station or stations, having received and decoded the quiet information, position(s) one or more network allocation vectors NAV according to the quiet information received. According to parameters describing the quiet interval comprised in the quiet element of a beacon frame, for example the duration of the quiet interval and its start time (set with respect to the TBTT (Target Beacon Transmission Time), the periodicity of the quiet interval, the beacon interval in which the quiet element is positioned, the NAV is positioned in the communication frame to correspond perfectly to the quiet interval, thus preventing any data from being sent to the station having positioned the NAV. In the case where several quiet elements are comprised in the beacon frame sent by an access point to which the stations receiving the beacon frame are associated, the stations position the NAV for each quiet element, the NAV thus positioned having parameters prohibiting any data from being sent to these stations, as described in the corresponding quiet elements.

Naturally, the invention is not limited to the embodiments previously described.

In particular, the invention is not limited to a network of the Wi-Fi® type according to the IEEE 802.11-2007 standard but extends to any wired or wireless network implementing a channel access method of the partially random type.

The invention also applies to a node or access point sending an item of quiet information according to the transmission method described according to the embodiments of the invention. The invention also applies to a node or station receiving an item of quiet information according to the reception method described according to the embodiments of the invention.

According to an advantageous implementation embodiment, the access point of each set of nodes transmits in a license-free frequency band, for example in the 2.4 GHz band or in the 5 GHz band. In an advantageous manner, the nodes of a set of nodes communicating in a license-free frequency band are capable of implementing a radar detection process.

In an advantageous manner, each access point sending an item of quiet information prohibits any transmission during the time slot or slots described in the quiet information.

According to a variant, an access point sends an item of quiet information to stations that are associated with it and that take measurements during the time slot or slots specified in the quiet information, for example for the detection of another set of nodes or BSS belonging or not belonging to the network formed by the BSSs (called ESS).

In an advantageous manner, all the sets of nodes (or BSS) forming a network (or ESS) use the same channel access method and the same communication protocols.

According to a variant, there are one or more time slots during which all the nodes of all the sets of nodes are prohibited to send to allow one of the nodes to take a measurement, for example a radar interferent detection measurement. According to another variant, there are one or more time slots during which all the nodes of all the sets are authorised to send, for example when a stream with no quality of service is sent, the reserved slots being used for streams with quality of service for which the risks of collisions and therefore loss of data must be limited.

According to another variant, the channel access method used by the sets of nodes of the network is of the TDMA (Time Division Multiple Access) or OFDMA (Orthogonal Frequency-Division Multiple Access) type.

1. Transmission method in a first set of nodes comprising a first access point and at least one station, wherein the method comprises a transmission step, implemented by said first access point, intended for at least one station of said first set, of at least one item of information representative of a prohibition to send during at least one allocated time slot allocated to at least one second set of nodes, said at least one item of information being comprised in at least one quiet element of a beacon frame.

2. Method according to claim 1, wherein the first set and the at least one second set use a same channel access method of the random access type.

3. Method according to claim 2, wherein the channel access method is a channel access method by carrier detection.

4. Method according to claim 1, wherein it comprises a reception step of an item of information representative of allocation of said at least one time slot.

5. Method according to claim 1, wherein it comprises a reception step of an item of information representative of a temporal synchronization.

6. Method according to claim 1, wherein, said at least one station is associated with said access point, and in that said at least one second set comprises an access point.

7. Method according to claim 1, wherein said first and second sets belong to a same network of the wireless local network type.

8. Method according to claim 1, wherein said first and second sets belong to a same network of the powerline type.

9. Reception method in a first set of nodes comprising a first access point and at least one station wherein it comprises a reception step, implemented by said at least one station, of at least one item of information representative of a prohibition to send during at least one time slot allocated to at least one second set of nodes, said information being received from the first access point of said first set, said at least one item of information being comprised in at least one quiet element of a beacon frame.

10. Method according to claim 9, wherein it comprises a positioning step of a network allocation vector (NAV) according to said at least one item of quiet information.

11. Method according to claim 9, wherein the first set and the at least one second set use a same channel access method of the random access type.

12. Method according to claim 11, wherein the channel access method is a channel access method by carrier detection.

13. Method according to claim 1, wherein it comprises a positioning step of a network allocation vector (NAV) according to said at least one item of quiet information.

14. Transmission device of a first set of nodes, wherein it comprises means for transmitting at least one item of information representative of a prohibition to send during at least one time slot allocated to at least one second set of nodes, said at least one item of information being comprised in at least one quiet element of a beacon frame.
